(19) United States
(12) Patent Application Publication
(10) Pub. No.: US 2011/0308336 A1
(43) Pub. Date: Dec. 22, 2011

(54) Methods and apparatus for specimen collection and transport

(75) Inventors: Christopher H. Harmston, Heber City, UT (US); Steven J. Smith, Mendon, UT (US)

(73) Assignee: Identigene, L.L.C., Salt Lake City, UT (US)

(21) Appl. No.: 13/134,722

(22) Filed: Jun. 15, 2011

Related U.S. Application Data
(60) Provisional application No. 61/397,895, filed on Jun. 16, 2010.

(51) Int. Cl. B01L 3/00

(52) U.S. Cl. 73/864.91; 422/552

(57) ABSTRACT

A specimen collection and transport kit comprising an external housing member for receiving a tray. A tray comprising a plurality of compartments for receiving a plurality of specimen handling tools and at least one opening configured to receive a specimen container in an upright position during use. Methods for handling a biological specimen including arranging a specimen container in an upright orientation within a tray and transferring a portion of the specimen between one or more receptacles. The methods may be used, for example, to collect and transport urine for urinalysis to diagnose a sexually transmitted disease.

### CROSS-REFERENCE TO RELATED APPLICATION

This application claims the benefit under 35 U.S.C. §119(e) of U.S. Provisional Patent Application No. 61/397,895, filed on Jun. 16, 2010, the entire disclosure of which is incorporated herein by this reference.

### FIELD OF THE INVENTION

The invention relates generally to apparatuses and methods for collecting and transferring biological specimens.

### BACKGROUND OF THE INVENTION

Devices for the collection and transport of biological specimens or samples have frequently been utilized by specially trained personnel, in a laboratory setting, to facilitate diagnosis and treatment of abnormal conditions. Recently, untrained persons have begun handling biological specimens, outside of laboratory settings, for example, in a physician's office or a private residence. However, to obtain accurate analytical results and protect the health and safety of persons handling the specimen, it is important to control how a specimen is manipulated during handling.

Historically, a biological specimen might be obtained by providing a user with the necessary components to collect, transfer, and/or transport the specimen. In some instances, the components may be provided to the user in a kit. A typical kit may include an assortment of components, for example, collection vessels, specimen containers, and transfer devices, hereinafter, collectively referred to as specimen handling tools or tools. The contents of a particular kit may vary depending on the application for which the kit is intended. For example, a kit designed for lipid analysis may contain tubes to collect blood; while a kit designed for certain genetic tests may include a buccal (cheek) swab.

Kits employing trays are available for a variety of applications. The trays may be either simple or compartmentalized and, typically, are used to organize the various components of the kit. However, one of the problems with these kits is that the specimen container(s) is not held in an upright, vertical position within the tray, during specimen handling (i.e. collection, assay, or transport). Instead, a user must either hold the specimen container or position a specialized specimen container, for example, a container with a flat bottom, on some other surface, such as a counter-top. This is undesirable because the user's dexterity to perform additional tasks may be inhibited. Further, the specimen container may be easily overturned contaminating the sample and/or the user's environment. Moreover, a specialized specimen container may require additional specimen handling steps because the container is not compatible with standard laboratory equipment. There is a need in the art for a biological specimen kit, and methods of using the kit, that provide the means to prevent contamination of a user or specimen, while simplifying handling procedures.

Therefore, it would be an improvement in the art to provide a kit having a tray designed to position and retain a specimen container in an upright position within the tray during specimen handling. It would be a further improvement to provide a method of collecting a biological specimen using a tray that prevents contamination of a specimen or user's environment. A tray for biological specimen collection, having at least one opening for receiving a specimen container therein during transport or analysis, is a further improvement in the art.

### SUMMARY OF THE INVENTION

The invention includes a kit for collecting and transporting biological specimens. The kit may include a tray having a plurality of openings or recesses, with at least one opening for receiving a specimen container in an upright position. The kit may include an external housing for receiving components of the kit including, for instance, a tray, instructional or directional materials, and transporting or mailing materials. Optionally, the kit may include packaging materials for containing a tray during transport to a remote or alternate location. The kit may also include the means for performing an analytical evaluation at the site of specimen collection.

The invention includes a tray designed and configured to facilitate correct specimen handling by any user. For example, the tray may stabilize a specimen container, positioned within an opening of the tray, during specimen collection, analysis, or transport. The tray may include a plurality of openings, compartments, or recesses, in which one or more specimen handling tools may be situated. At least one of the openings in the tray may include ribs, for example, to facilitate a press-fit with an upright specimen container. Additionally, one or more of the openings in the tray may, optionally, have a bottom surface having a non-zero slope. One or more of the openings in the tray may conform to a specimen handling tool to be positioned therein.

The invention also includes methods of collecting a biological specimen using a tray designed and configured to position and hold specimen handling tools. The methods may include collecting a biological specimen from an untrained user. The methods may include moving a specimen container between recumbent and upright orientations. The methods may include transferring a specimen between one or more receptacles. The methods may include transporting a specimen, supported within a tray, to a different location, for example, a remote testing facility.

### BRIEF DESCRIPTION OF THE SEVERAL VIEWS OF THE DRAWINGS

FIG. 1 is a perspective view of an embodiment of a tray used in a specimen collection and transport in accordance with an embodiment of the present invention;

FIG. 2 is a perspective view of an embodiment of the tray shown in FIG. 1 including specimen handling tools positioned therein;

FIG. 3 is a perspective view of an embodiment of a kit comprising a tray, one or more specimen handling tools, and an external housing; and

FIG. 4 is a cross-sectional view of an embodiment of the tray shown in FIG. 1.

### DETAILED DESCRIPTION OF THE INVENTION

The present invention provides methods of collecting and manipulating biological specimens and apparatuses for handling biological specimens that have advantages over currently known specimen handling systems, methods, and devices. It will be appreciated by those skilled in the art that the embodiments described in this disclosure, while illustrating certain specific and exemplary embodiments, are not intended to limit the scope of the invention or of the appended claims. Those of ordinary skill in the art will also understand that various combinations or modifications of the disclosed embodiments may be made without departing from the scope of the invention.

As used herein, the term “user” means and includes any person collecting, analyzing, or transporting a biological specimen, for example, medical and laboratory personnel, as well as, untrained or at-home individual use.

As used herein, the term “biological specimen” means and includes any portion of material, exemplifying a whole, that is derived from a biological source, such as an animal, plant, or microorganism, to be used in analysis. A biological specimen may include, for example, tissue, blood, or urine taken from a human source.

As used herein, the terms “specimen container” and “collection vessel” mean and include any receptacle in which a biological specimen may be held or contained without compromising the integrity of the specimen or the container. A specimen container or collection vessel may include, for example, a vial, a cup, a tube, a jar, or a pouch.

As used herein, the term “upper surface” means and includes the portion of the tray parallel to an underlying support surface and spaced apart from the underlying surface by sidewalls. As used herein, the term “base” means and includes the portion of the tray adjacent to an underlying support surface, upon which the tray may rest.

As used herein, the term “horizontal” means and includes an orientation in which the major axis of a tool is parallel to or in the plane of the upper surface of the tray. As used herein, the term “upright” means and includes an orientation in which the major axis of a tool is generally orthogonal or perpendicular to the plane of the upper surface of the tray. In some instances, “upright” may refer to a vertical orientation, while in other instances, the orientation may be such that the major axis of the tool intersects the upper surface of the tray at an angle which is substantially vertical (between 75 and 105 degrees).

As used herein, the term “recumbent” means and includes an orientation in which the major axis of a tool may be angled relative to the plane of the upper surface of the tray and wherein the angle is less than ninety degrees. For example, recumbent, as used herein, may refer to a range of orientations from lying flat (horizontal) to substantially declined.

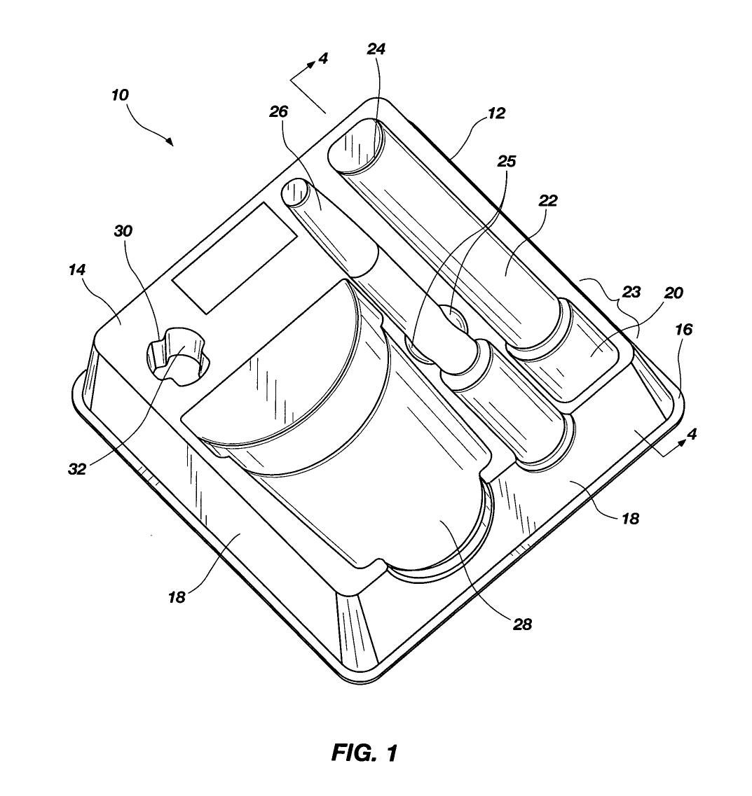

FIG. 1 is a top view of an embodiment of a tray 10 in accordance with the present invention, which may be used in conjunction with a biological test kit, described in further detail below. As shown in an embodiment in FIG. 1, the tray 10 may comprise a frame 12 having a generally planar upper surface 14 opposite a generally planar base 16, with sides 18 extending between the upper surface 14 and the base 16. The frame 12 may be capable of supporting various specimen handling tools and may be resistant to deformation. The frame 12 may comprise any rigid or semi-rigid material. For example, the frame 12 may comprise a thermoplastic material, a corrugated cardboard or a polystyrene foam. Additionally, the frame may be monolithic or may comprise a plurality of associated parts.

The upper surface 14 of the frame 12 may have instructions and/or identifying marks printed/imprinted thereon. Further, the upper surface 14 of the frame 12 may have a plurality of openings or recesses formed therein. The plurality of openings may be arranged such that none of the plurality of openings is in contact with another of the plurality of openings. The plurality of openings may be substantially the same size. Alternatively, the plurality of openings may be of different sizes. In some embodiments, at least one of the plurality of openings is of a different size than at least another of the plurality of openings. The openings may be sized and configured to receive a variety of components, including specimen handling tools, provided with a biological test kit. One or more of the plurality of openings in the upper surface 14 may be sized and configured to maintain a tool in a recumbent position within the frame 12. Additionally, at least one of the openings in the upper surface 14 may be sized and configured to retain a tool in an upright position (the major axis of the tool perpendicular to or intersecting the plane of the upper surface 14 of the tray 10) within the frame 12.

As shown in FIG. 1, the upper surface 14 of the frame 12 may include at least one opening 20 sized and configured to receive a specimen container. The at least one opening 20 may have a structure which retains the specimen container in a recumbent position. The specimen container positioned within the at least one opening 20 may include any receptacle capable of retaining a specimen without leaking or degradation. In addition, the specimen container may comprise a closure mechanism that sealingly engages with the container to prevent loss or contamination of the specimen. The closure mechanism may comprise any known mechanism in the art such as a threaded cap, a hinged lid, a plug, and similar mechanisms. For example, the closure mechanism may include an injection cap having a rubber or foil diaphragm under a threaded cap to allow needle insertion into the specimen container.

The opening 20 may form a recess or compartment defined by opposing sidewalls 22 and a bottom surface 24. The sidewalls 22 may extend various depths between the upper surface 14 and the bottom surface 24 of the opening. For example, the sidewalls 22 may depend from the upper surface 14 a depth sufficient to retain the specimen container within the frame 12 until removed by the user. By way of example and not limitation, the sidewalls 22 may depend from the upper surface 14 a depth of about one-quarter to about one-half of the external diameter of the specimen container to be stored therein (i.e. an upper portion of the specimen container extends above the upper surface when the specimen container is positioned therein). In other examples, the sidewalls 22 may depend from the upper surface 14 a depth equal to or greater than the external diameter of the specimen container to be stored therein (i.e. an upper portion of the specimen container is coplanar with or recessed relative to the upper surface when the specimen container is positioned therein). Further, the sidewalls 22 may depend different depths from one portion of the opening to another. For example, the sidewalls 22 may depend a first distance in one portion of the opening 20 and a second greater distance in another portion of the opening 20. In other embodiments, the depth the sidewalls depend from the upper surface 14 may continuously increase or decrease along the entire length of the opening 20.

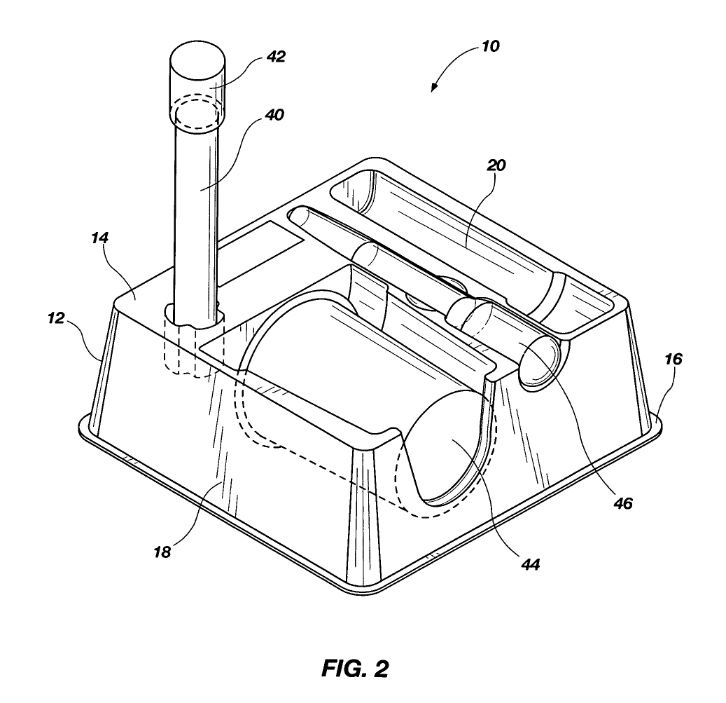

The sidewalls 22 of the opening 20 may be aligned or may comprise one or more offset portions. In an embodiment, the sidewalls 22 may include one or more regions 23 wherein the distance between the sidewalls 22 along one portion of the opening 20 is greater than the distance between the sidewalls 22 along another portion of the opening 20. For example, the opening 20 may be sized and configured to receive a specimen container 40 having a first dimension and a cap 42, associated with the specimen container, having a second different dimension. (FIG. 2).

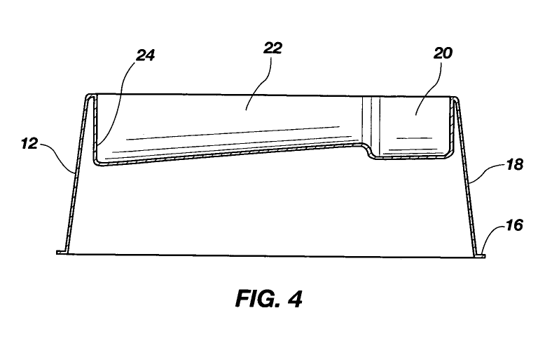

The opening 20 may also be defined by a bottom surface 24. The bottom surface 24 of the opening 20 may be flat or planar. In the alternative, the bottom surface 24 of the opening 20 may have a curvature. In some embodiments, the bottom surface 24 of the opening 20 may conform to a specimen container positioned therein. Further, in some embodiments, the bottom surface 24 may be parallel to the plane of the upper surface 14 of the tray 10. In other embodiments, the bottom surface 24 may be slanted relative to the plane of the upper surface 14 of the tray 10 (i.e. have a non-zero slope). For example, the bottom surface 24 may have a slope sufficient to cause preservative fluid, optionally present in the container, to flow toward, and be confined in, a lower portion of the specimen container that is positioned within the opening 20. An embodiment of a tray 10 having a slanted bottom surface is illustrated in FIG. 4, which depicts one potential cross-section view of opening 20 along the line 4-4 indicated in FIG. 1.

With continued reference to FIG. 1, the tray 10 may include another opening 26 in the upper surface 14 of the frame 12 that is sized and configured to receive a specimen transfer apparatus. The opening 26 may position the specimen transfer apparatus in a recumbent orientation within the tray 10. The opening 26 may include sidewalls and a bottom surface having substantially similar properties as the sidewalls and bottom surface described above with respect to opening 20. Specifically, as described above, the sidewalls may be aligned or have a plurality of offset portions (where the distance between sidewalls varies along the length of the opening). Further, the bottom surface may be flat, curved, or conform to the specimen transfer apparatus. The bottom surface may be horizontal or may have a non-zero slope. The sidewalls of the opening 26 may depend to one or more depths from the upper surface 14 of the frame 12. For example, the sidewalls of the opening 26 may depend from the upper surface 14 such that when a specimen transfer apparatus is located within the opening 26, a first end of the transfer apparatus is recessed relative to the upper surface 14, while a second end of the transfer apparatus is coplanar with the upper surface. In addition, at least a portion of the opening 26 may be longitudinally tapered, i.e. shaped such that the sidewalls of the opening 26 converge in the plane of the upper surface 14.

As illustrated in FIG. 1, the tray 10 may comprise another opening 28 in the upper surface 14 of the frame 12 that is sized and configured to receive a specimen collection vessel. The specimen collection vessel may be in a recumbent position within opening 28.

The opening 28 may include sidewalls and a bottom surface having substantially similar characteristics as described above with respect to the other openings 20, 26. Specifically, as described above, the sidewalls of the opening may be aligned, tapered, have offset portions, or combinations thereof. The bottom surface may be flat, curved, or conform to the specimen collection vessel. Moreover, the bottom surface may be either slanted relative to the upper surface 14 of the frame 12, or parallel to the upper surface 14 of the frame 12. The depth from the upper surface 14 of the frame 12 that the sidewalls depend may be uniform or may vary. For example, the sidewalls of the opening 28 may depend from the upper surface 14 a depth of about one-quarter to about one-half of the major diameter of the specimen collection vessel to be stored therein. In other examples, the sidewalls of opening 28 may depend from the upper surface 14 a depth equal to or greater than the diameter of the specimen collection vessel to be stored therein. Additionally, the sidewalls of the opening 28 may depend a first depth in one region and another depth in at least another region. In some embodiments, each of the plurality of openings 20, 26, 28 has a depth such that a top surface of the specimen handling tool contained therein is coplanar with the upper surface 14 of the frame 12. In other embodiments, each of the plurality of openings 20, 26, 28 has a depth such that a top surface of the specimen handling tool contained therein is recessed relative to the upper surface 14 of the frame 12. In still further embodiments, each of the plurality of openings has a depth such that at least a portion of the specimen handling tool contained therein extends vertically above the upper surface 14 of the frame 12. Additionally, each of the plurality of openings 20, 26, 28 may include one or more notches 25 to allow a user access to grasp a specimen handling tool when it is seated within the openings.

The tray 10 of the present invention may comprise at least one opening or recess in the upper surface 14 that is sized and configured to retain a tool in an upright position within the frame 12. Referring again to FIG. 1, in an embodiment of the invention, the frame 12 may comprise an opening 30, in the upper surface 14, for receiving a specimen container vertically therein, i.e. such that the major axis of the specimen container is substantially perpendicular to the plane of the upper surface 14 of the frame 12. The opening 30 may be defined by sidewalls 32 depending from the upper surface 14. For example, the sidewalls 32 may form a cylindrical recess. Alternatively, the sidewalls 32 may form a polygonal recess, optionally, including a plurality of symmetrically arranged ribs, wherein portions of the sidewalls protrude toward the center of the opening. For example, the sidewalls 32 may comprise a series of grooves or channels separated by raised portions. In such a configuration, only the raised portions of the sidewalls 32 contact the specimen container when it is positioned vertically within the opening 30. The ribs, when present, may facilitate retention of the specimen container in an upright position within the opening 30 by increasing the frictional force between the sidewalls 32 and the specimen container.

The sidewalls 32 of the opening 30 may be vertically tapered, i.e. continuously converging from the upper surface 14 of the frame 12 towards the base 16 of the frame 12, such that the diameter of the opening at the bottom is less than the diameter of the opening at the top (i.e. near the upper surface 14 of the frame 12). Further, the dimensions of the opening 30 may be increased or decreased to accommodate specimen containers of various sizes.

The sidewalls 32 of the opening 30 may depend from the upper surface 14 a depth sufficient to retain a specimen handling tool in the upright position. For example, the sidewalls 32 may depend from the upper surface 14 of the frame 12 to a depth equal to about one-third of the length of the major axis of the specimen container. In other examples, the sidewalls 32 may depend from the upper surface 14 of the frame 12 to a depth less than about one-half of the length of the major axis of the specimen container. In still other examples, the sidewalls 32 may depend from the upper surface 14 substantially the entire width of the sides 18 of the frame 12, terminating immediately above the base 16 of the frame 12. In yet other examples, the depth of the sidewalls 32 is determined in relation to the specimen container to be used. For example, certain specimen containers provide markings, e.g. graduated reference numerals, for reference by the user during specimen handling. The specimen container may also include a volume indicator comprising a window through which the specimen in the container may be viewed. It is desirable that such markings and indicators are visible above the upper surface 14 of the frame 12. Accordingly, the depth of the sidewalls 32 of the opening 30 may be adjusted to insure that reference features on a specimen container positioned therein are adequately displayed.

The opening 30 may include a bottom surface, wherein an outer perimeter of the bottom surface is coincident with the sidewalls. The bottom surface may be flat, rounded, or conforming to the specimen container. The bottom surface may act as a secondary containment in case of specimen spillage during collection, transfer, or analysis. In some embodiments, an absorbent material may overlie the bottom surface. The bottom surface may be useful in avoiding contamination of the user's environment by preventing any specimen that escapes the specimen container from contacting an underlying support surface (e.g. countertop). In some embodiments, the opening 30 may lack a bottom surface. When opening 30 is without a bottom surface, the sidewalls 32 may terminate at or above the plane of the base 16 of the frame 12, and a bottom portion of the specimen container may extend below the sidewalls 32 when the specimen container is positioned within the opening 30.

The tray 10 may comprise a plurality of openings or compartments (20, 26, 28) for receiving a plurality of instrument handling tools, such as, a specimen container, a specimen transfer apparatus, and a specimen collection vessel. A specimen container may include any receptacle capable of retaining a specimen without leaking or degradation. A transfer apparatus may comprise any tool useful for moving a specimen from one location to another. In some embodiments, the transfer apparatus may comprise a plastic disposable pipette. In other embodiments, the transfer apparatus may comprise a glass pipette and rubber bulb. In still further embodiments, the transfer apparatus may comprise a spatula, a swab or similar instruments in the art. The specimen collection vessel may comprise any receptacle suitable for collection of a biological specimen from a user. For example, the specimen collection vessel may comprise a cup, a bottle, a jar, a tube, a pouch, a syringe, and other collection vessels. The specimen collection vessel may include a closure mechanism for sealing the vessel, for example a threaded lid.

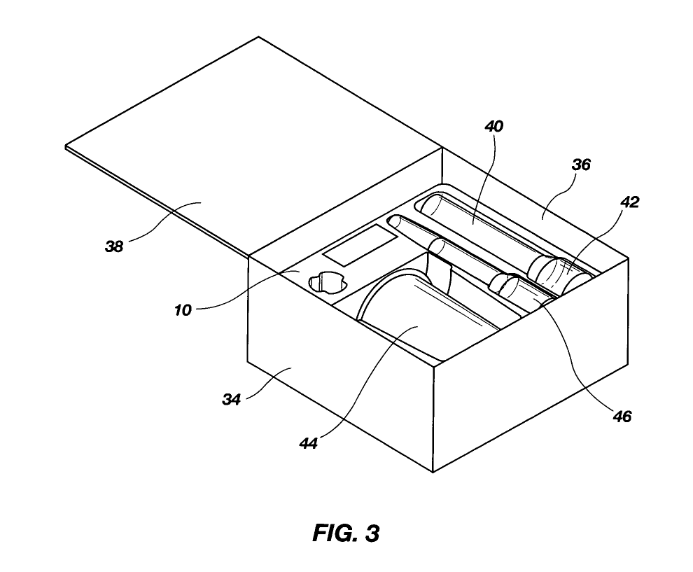

As shown in FIG. 3, the tray 10 of the present invention may be associated with, inter alia, an external housing 34 to form a kit. The external housing 34 may be sized and configured to accommodate the tray 10 within the housing. For example, the tray 10 may be slidably inserted into the housing 34, such that the sides 18 of the tray 10 are surrounded by and immediately adjacent to an interior surface of the sidewalls 36 of the external housing 34. In another embodiment of a kit in accordance with the present invention, the dimensions of the external housing may be greater than the dimensions of the tray 10. For example, when it is associated with the external housing 34, the tray 10 may occupy a portion of the internal space of the housing 34, while another portion of the internal space remains available to receive other components of the kit. In particular, additional components of the kit (e.g. instructions, packaging materials, etc.) may be located laterally adjacent to the tray 10 in the available internal space within the housing 34.

In some embodiments, the upper surface 14 of the tray 10 may be recessed relative to the top or upper surface of the sidewalls 36 of the external housing 34. Accordingly, additional components of the kit (e.g. instructions, packaging materials, etc.) may overlie the tray 10, without extending vertically beyond the top of the sidewalls 36 of the external housing 34. In other embodiments, at least a portion of the upper surface 14 of the tray 10 may be coplanar with an upper surface of the sidewalls 36 of the external housing 34. In addition, the external housing 34 may include a lid 38. The lid 38 may be attached to or contiguous with at least one sidewall 36 of the external housing 34. Alternatively, the lid 38 may be separate from the external housing 34. A separate lid 38 should be capable of associating with the external housing 34, in order to confine the components of the kit, including the tray 10, within the external housing 34. The lid 38, optionally, may have instructions for using the kit printed thereon. Likewise, one or more of the sidewalls 36 of the external housing 34, optionally, may have instructions for using the kit printed thereon.

Also disclosed, are methods of using a test kit and tray, as described herein, to collect a biological specimen. In particular, the present invention includes a method of collecting a biological specimen using a tray having at least one opening configured to position a specimen container in an upright orientation. A test kit comprising an external housing 34, a tray 10, and a plurality of specimen handling tools seated within openings or recesses in the tray is provided to a user. The test kit may include a means for analysis of the specimen at the site of collection and/or packaging materials for transport of the specimen to a remote location for analysis. The user may be a trained or untrained person, and the test kit may be provided at various locations (e.g. physician's office, user's home, medical lab). Prior to use, the tray of the kit may display a plurality of specimen handling tools, seated in a recumbent position, within a plurality of openings in the upper surface of the tray. In addition, providing the tray may comprise providing a tray having one or more openings, without a tool seated therein, configured to position a specimen handling tool vertically within the tray (FIG. 2).

The user may place the external housing 34 of the test kit on a supporting surface, such as a table or countertop. The user may open the test kit by lifting or removing the lid 38 of the external housing 34. In some embodiments, the user performs specimen collection while the tray 10 is located within the external housing 34. In other embodiments, the user may remove the tray 10 from the external housing 34 and position the tray 10 upon a supporting surface. A user may remove at least one specimen container 40 (FIGS. 2-3) from a first opening 20 within the tray 10 and deposit the container 40 coaxially into a second opening 30 of the tray 10, so that the container 40 is in an upright position within the second opening 30 (FIG. 2). Removing and depositing the specimen container 40 may comprise rotating the container from a recumbent orientation to an upright orientation. The closure mechanism (cap) 42 of the specimen container 40 may be loosened, to facilitate subsequent removal, while remaining substantially in position over the internal cavity of the container 40.

The user may remove the specimen collection vessel 44 from the tray 10 and prepare the vessel 44 for receiving the specimen. The user may then introduce a biological specimen into the vessel 44. How the specimen is acquired and introduced into the specimen collection vessel will vary depending on the type of specimen collected. The user may be provided information on how to collect the specimen in instructions optionally included with the kit. Once the specimen has been received into the vessel 44, the specimen transfer apparatus 46 may be removed from the tray 10. Further, the cap 42 may be removed from the specimen container 40. Using the specimen transfer apparatus 46 the user may transfer at least a portion of the biological specimen from the specimen collection vessel 44 to the specimen container 40, which is held upright within the tray 10. The user may transfer enough of the specimen to fill the specimen container 40. In other examples, the user may transfer enough of the specimen to fill a portion of the specimen container 40, for example, up to a designated volume. A designated volume may be indicated with one or more reference markings on the specimen container 40 that are visible above the upper surface 14 of the tray 10. The cap 42 may be replaced onto the specimen container 40, to confine the specimen within the container 40.

Once the specimen has been collected, the user may either perform an analysis on the specimen immediately or the user may transport the specimen to a remote testing facility, or a combination thereof. For example, the user may introduce a test card into the specimen container, which may indicate, usually by color, the presence or absence of an analyte. In another example, the user may return the specimen container 40 to the first opening 20 in the tray and transport the specimen container 40, in the tray 10, to a remote testing facility. In this example, the specimen container is maintained in a recumbent orientation within the tray during transport. Alternatively, the specimen container may be transported while in the upright position within the tray.

In an embodiment of the present invention, packaging materials comprising an envelope or pouch, an absorbent pad, and labeling materials are provided in the kit. The absorbent pad may comprise any absorbent or desiccant material capable of taking in liquid, especially the type of liquid of the specimen. The user may enclose the absorbent pad and the tray (containing the specimen) within the envelope. A label may be affixed to the exterior of the envelope, and/or to the exterior of the specimen container, and the user may mail the combination of the envelope, tray, and specimen container (with specimen) to a testing facility. In other examples, once the specimen container 40 has been appropriately filled, it is removed from the tray 10, labeled, and enclosed in packaging materials provided in the kit (optionally) for safe transfer to a remote testing facility.

The following provides a nonlimiting example of an embodiment of the present invention as described in this disclosure. A user (e.g. untrained) may purchase a home test kit, from a pharmacy or general store, for the purpose of diagnosing, for example, a sexually transmitted disease. When ready to perform the test, the home user may remove the tray (10) from the box (34) and place the tray on a support surface, a bathroom countertop, for example. The kit may include, among other things, a test tube and cap (40, 42), a disposable pipette (46), and a standard sample cup and lid (44) displayed in a recumbent position within openings in the surface of the tray (10), as described above. The test tube may contain a small amount of preservative for maintaining the specimen post collection. The home user may remove the test tube from its recumbent position in the tray and rotate the tube into an upright orientation. The home user positions the test tube coaxially into the designated opening (30) in the tray by applying a downward force along the major axis of the tube while in position over the opening. The home user may loosen the cap of the test tube.

The home user may remove the sample cup from within the tray and collect a biological specimen. For example, using the opened cup, the user may interrupt a stream of urine produced by the user, thereby, collecting a volume of urine in the sample cup. The user may remove the pipette from the tray and use it to transfer a quantity of urine from the sample cup to the opened test tube, held vertically within the tray. The home user may transfer enough urine to fill the test tube to a volume indicated by a reference marking on the tube. The user replaces the cap on the test tube to confine the urine inside and prevent spills or cross-contamination. A label, optionally provided in the kit, may be affixed to a surface of the test tube. The user may dispose of the sample cup, and pipette. The test tube, containing the specimen, may be restored to a recumbent position within the tray, for example, seated in the original opening from which it was removed. The user may seal the tray and specimen within an envelope containing an absorbent material. The envelope may be labeled and transported to a remote testing facility so that laboratory personnel may analyze the specimen for indicators of a sexually transmitted disease.

While the present invention has been describe herein with respect to certain preferred embodiments, those of ordinary skill in the art will recognize that the invention is not so limited. Rather many additions, deletions, and modifications may be made without departing from the scope of the invention as hereinafter claimed. In addition, features of one embodiment may be combined with features of another embodiment while still being within the scope of the invention as contemplated by the inventor.

What is claimed is:

1. A tray for use in biological specimen handling, comprising:
a frame comprising an upper surface, a base, and sides; and
a plurality of recesses in the upper surface of the frame, wherein at least one recess is defined by sidewalls having one or more grooves and one or more ribs.

2. The tray of claim 1, wherein at least one of the plurality of recesses in the upper surface of the frame conforms to an outer dimension of a specimen handling tool.

3. The tray of claim 2, wherein another of the plurality of recesses in the upper surface of the frame conforms to an outer dimension of a different specimen handling tool.

4. The tray of claim 1, wherein the sidewalls of the at least one recess depend a distance from the upper surface that is about one-third of the length of the major axis of a specimen container to be positioned in the recess.

5. The tray of claim 1, wherein the at least one recess is sized and configured to hold a specimen container in an upright position within the recess, such that a reference marking on the specimen container is visible above the upper surface of the tray.

6. The tray of claim 1, wherein at least another of the plurality of recesses comprises a bottom surface having a non-zero slope.

7. The tray of claim 1, further comprising a specimen container coaxially inserted into the at least one recess, and wherein the one or more ribs are in contact with the specimen container.

8. A method of handling a biological sample, comprising:
providing a kit comprising an external housing, a tray, and specimen handling tools comprising a specimen container, a specimen transfer tool, and a collection vessel;
arranging the specimen container in a specimen receiving position, wherein arranging the specimen container comprises removing the specimen container from an opening in the tray and inserting the specimen container into another opening in the tray, the another opening having one or more channels separated by one or more ridges;
delivering a biological specimen from a user to the collection vessel; and
transferring the biological specimen from the collection vessel to the specimen container.

9. The method of claim 8, wherein arranging the specimen container in a specimen receiving position comprises orienting the major axis of the specimen container transverse to the plane of an upper surface of the tray.

10. The method of claim 8, wherein transferring the biological specimen from the collection vessel to the specimen container comprises using the specimen transfer tool to convey a portion of the biological specimen sufficient to fill the specimen container at least to a reference mark.

11. The method of claim 8, further comprising transporting the specimen container to a remote testing location.

12. The method of claim 11, wherein transporting the specimen container to a remote testing location comprises:
returning the specimen container, containing the biological specimen, to the opening in the tray;
positioning the tray within an envelope containing an absorbent material; and
conveying the envelope to the remote testing location.

13. The method of claim 12, wherein delivering a biological specimen from a user comprises collecting urine in the collection vessel.

14. The method of claim 13, further comprising performing a urinalysis to diagnose a sexually transmitted disease.

15. A test kit for collecting a specimen for a diagnostic procedure, comprising:
an external housing having a lid and sidewalls defining an interior space;
a tray having an upper surface and an opposing base, wherein the upper surface has a plurality of recesses for supporting, displaying, and transporting a plurality of specimen handling tools;
a plurality of specimen handling tools comprising at least one specimen container, at least one specimen transfer apparatus, and at least one specimen collection vessel, wherein each of the plurality of specimen handling tools are seated in a recumbent position within one of the plurality of recesses; and
one or more additional openings in the tray sized and configured to receive the at least one specimen container in an upright position.

16. The test kit of claim 15, wherein the tray occupies a portion of the interior space of the external housing.

17. The test kit of claim 15, wherein the upper surface of the tray is recessed relative to an upper surface of sidewalls of the external housing.

18. The test kit of claim 15, wherein each of the plurality of recesses in the upper surface of the tray conforms to an outer dimension of the specimen handling tool seated therein.

19. The test kit of claim 15, wherein the one or more additional openings in the tray comprise sidewalls depending from the upper surface of the tray defining a generally cylindrical recess having at least one rib.

20. The test kit of claim 19, wherein at least one of the plurality of recesses comprises a slanted bottom surface.
